(19) United States
(12) Patent Application Publication
(10) Pub. No.: US 2007/0273120 A1
(43) Pub. Date: Nov. 29, 2007

(54) Longitudinal Beam for a Driver's Cab and Carrier Structure Comprising One Such Longitudinal Beam

(75) Inventor: Herbert Fischer, Weil Der Stadt (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/572,094

(22) PCT Filed: Aug. 14, 2004
(86) PCT No.: PCT/EP04/09139

§ 371 Date: Feb. 8, 2007

(30) Foreign Application Priority Data
Sep. 18, 2003 (DE) 103-43-138.1

(51) Int. Cl. B60G 9/02

(52) U.S. Cl. 280/124.116; 180/89.18

(57) ABSTRACT

A longitudinal beam for a driver's cab which extends upward in an angular manner beyond a floor plate. An essentially straight longitudinal beam section is assembled with a separate longitudinal beam head.

This application is a national phase application of International application PCT/EP2004/009139 filed Aug. 14, 2004 and claims the priority of German application No. 103 43 138.1, filed Sep. 18, 2003, the disclosure of which are expressly incorporated by reference herein.

### BACKGROUND AND SUMMARY OF THE INVENTION

The invention relates to a longitudinal beam for a driver's cab and to a carrier structure comprising one such longitudinal beam extending upward in an angular manner beyond a floorplate.

As is known, a driver's cab for a commercial vehicle does not have deformation zones customary in the passenger vehicle sector, such as, for example, an engine compartment which is situated in front of a passenger cell. Occupant protection in the commercial vehicle sector therefore has to be obtained via additional measures.

Laid-open specification DE 101 24 271 A1, which forms the generic type, discloses a carrier structure for a driver's cab of a commercial vehicle with longitudinal beams made from hollow profiles or U profiles that are arranged below a floor plate. The longitudinal beams extend upward in an angular manner beyond the floor plate, with the free ends of the upwardly protruding longitudinal beam regions being connected to a transverse beam. This has the effect of improving the occupant protection in the driver's cab while retaining a stiffening floor structure.

Laid-open specification WO 03/029069 A1 discloses a straight, hydroformed longitudinal beam to which a stamped sheet-metal piece is fitted as a retaining element for a door element. Laid-open specification DE 100 07 664 A1, but also JP 2001039345 A, disclose a longitudinal beam to which a straight hollow profile, which protrudes at an angle, is fitted.

U.S. Pat. No. 5,863,093 A1 discloses two parallel longitudinal beams to which a front wall is fitted on mounts on the end side.

The invention is based on the object of indicating a longitudinal beam and a carrier structure with which the occupant protection can be further improved and, in addition, production-friendly and precise machining of the longitudinal beam is possible.

The longitudinal beam according to the invention is assembled from an essentially straight longitudinal beam section and a separate longitudinal beam head. The individual parts can be manufactured separately and their properties adapted at the particular installation site in accordance with their task. Furthermore, the longitudinal beam head can be provided with a multiplicity of functions, it being easier, as a compact component, to machine than an extended longitudinal beam body.

The elastic properties of the individual parts can be optimized by a different selection of material and/or shaping. By connecting the longitudinal beam head to the longitudinal beam section in a connecting region, a preferred angled shape of the entire longitudinal beam can be produced. The longitudinal beam head is formed in an angular manner from a first connecting piece pointing to a longitudinal beam section and an upwardly protruding second connecting piece, the longitudinal beam head can form a transition to an end wall of a driver's cab. A torque-proof design of the transition from the end wall to the longitudinal beam section which is assigned to a floor assembly is therefore possible. This is favorable particularly in the case of a floor assembly which has a what is referred to as sandwich floor. The safety of the driver is increased, and a survival space is improved in the case of a collision and in the case of a pendulum impact.

Furthermore, a plurality of connections is integrated in the longitudinal beam head. As a result, all of the essential connecting points for the components of the driver's cab can be provided in a compact space in this longitudinal beam head. The design of the longitudinal beam head as a cast part makes it possible for said connecting points to be provided in a dimensionally accurate manner with respect to one another. This facilitates the installation, is production-friendly, reduces production waste and saves an expensive and time-consuming finishing effort.

If the first connecting piece is of solid design, an advantageous and stable connection to the longitudinal beam section can be achieved. Apertures can be provided without impairing the stability of the connecting piece.

If the second connecting piece is of approximately U-shaped design, a multiplicity of connecting points can be provided there. Webs protruding vertically or at an angle provide possibilities for receiving components.

If the longitudinal beam head is designed as a cast part, a large number of functions, such as connections or mountings, can be integrated in a single part in a very simple and production-friendly manner. A cast-steel material with a high degree of extension is preferably used. A longitudinal beam head of this type can be machined, for example, on a machining center, so that all of the bearing and connecting points have extremely high dimensional accuracy to one another. Furthermore, the design as a cast part signifies a torque-proof transition region from an upwardly angled connecting piece to a straight longitudinal beam section below a floor plate. This permits the driver's cab bearing to be integrated in the longitudinal beam or longitudinal beams, which therefore also serve as a means of supporting the driver's cab on the carrier structure of the vehicle irrespective of whether the driver's cab is mounted in a tiltable or fixed manner on the carrier structure.

If a connection for a shock absorber is provided between webs of the second connecting piece, which webs protrude at an angle to an end wall, a connection which is simple to produce can be provided between the shock absorber for the driver's cab mounting and the longitudinal beam.

If a connection for a rotary bearing of a damper is provided between webs, which protrude at an angle, of the second connecting piece, a connection which is simple to produce can be provided between the damper for the driver's cab mounting and the longitudinal beam.

If a connection for a pedal bracket and/or a steering column fastening is provided on the second connecting piece, a connection which is simple to produce can be provided between the longitudinal beam and the pedals and/or the steering column. It is particularly favorable to use a combination bracket for the pedals and the steering column fastening.

If the longitudinal beam section is of U-shaped design, with limbs of the U shape pointing upward, the longitudinal beam section forms a particularly stiff and stable arrangement.

If the longitudinal beam head projects with its first connecting piece into the U shape of the longitudinal beam section, this forms a secure mounting for the longitudinal beam head, for the first connecting piece of the longitudinal beam head that can rest on the base part of the U profile.

If a connection for a bracket for a driver's cab is provided in the transition of the longitudinal beam head from the first to the second connecting piece, the bracket or the driver's cab bearing for a tiltable driver's cab can be integrated in the transition region from longitudinal beam into the end wall and can at the same time serve as a means of support. If another pivotal point of the driver's cab bearing is desired, the bracket can simply be exchanged for another one.

If an aperture for a steering column is provided in the first connecting piece, a compact arrangement is produced. The solid design of the first connecting piece enables the necessary stability of the longitudinal beam overall to be maintained.

If a connection for a tilting cylinder is provided in the region of the connecting region, this produces a compact connection, which is simple to produce, of the longitudinal beam to the tilting cylinder with which the driver's cab can be tilted.

If at least two longitudinal beams are provided parallel to a vehicle longitudinal axis and their second connecting pieces protruding upward beyond a floor plate are connected to a transverse beam, a stable carrier structure with improved occupant safety is provided. Those upwardly protruding ends of the longitudinal beams which protrude beyond the floor plate result, in conjunction with the transverse beam, which is enclosed in the carrier structure, in a stiff connection of the carrier structure to the driver's cab, so that, in particular, the front of the driver's cab is designed to be especially reinforcing for a frontal impact. In the case of impact forces which act on the front of the driver's cab, these can be absorbed by the upwardly protruding connecting pieces and conducted directly into the floor assembly, so that an intrusion of the end wall can be avoided.

If the transverse beam is integrated in an end wall, a favorable torque-proof deflection of forces from the longitudinal beam into the end wall and vice versa is produced.

If a bracket is integrated in a transition between longitudinal beam and end wall, a means of supporting the driver's cab on the front driver's cab bearing can be achieved at the same time.

Other objects, advantages and novel features of the present invention will become apparent from the following detailed description of the invention when considered in conjunction with the accompanying drawings for example.

### BRIEF DESCRIPTION OF THE DRAWINGS

FIG. 1 shows a view of a carrier structure with a floor assembly and a transverse beam of the end wall in accordance with an embodiment of the present invention,

FIG. 2 shows a detailed view of the longitudinal beam with the longitudinal beam head of FIG. 1,

FIG. 3 shows a view of the longitudinal beam head of FIG. 1 from a different viewing angle, and

FIG. 4 shows a lateral view of the longitudinal beam head of FIG. 1 with a bracket for the driver's cab.

### DETAILED DESCRIPTION

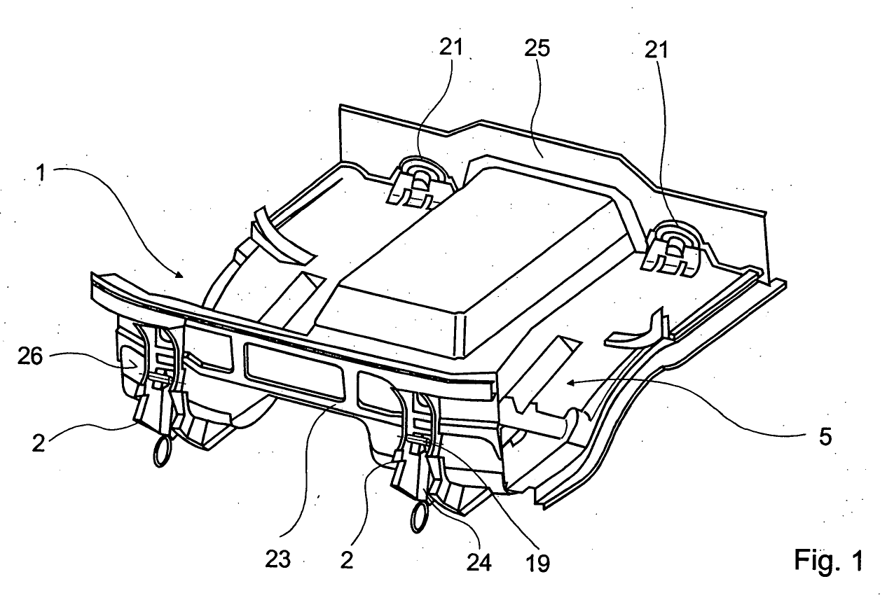

FIG. 1 shows a view of a carrier structure 1 with a floor assembly. Identical parts are basically numbered with the same reference numbers in the figures. A floor plate 5 is arranged between a rear wall 25 and an end wall 26. Extending below the floor plate 5 are two longitudinal beams 2 which run parallel to a vehicle longitudinal axis, are fastened to the rear wall 25 by fastenings 21 and protrude forward beyond the floor plate 5 with a respective longitudinal beam head 4 which is angled upward. The free ends of the longitudinal beam heads 4 are connected to a transverse beam 23 of the end wall 26. The position of the longitudinal beams 2 is selected in such a manner that a driver's seat module (not illustrated) is connected into one of the longitudinal beams 2 in accordance with the side of the vehicle at which a steering column is mounted, and the longitudinal beam 2 is arranged in the center of the driver's workplace. Further details of the carrier structure 1 such as frame elements of the driver's cab and the like are not illustrated.

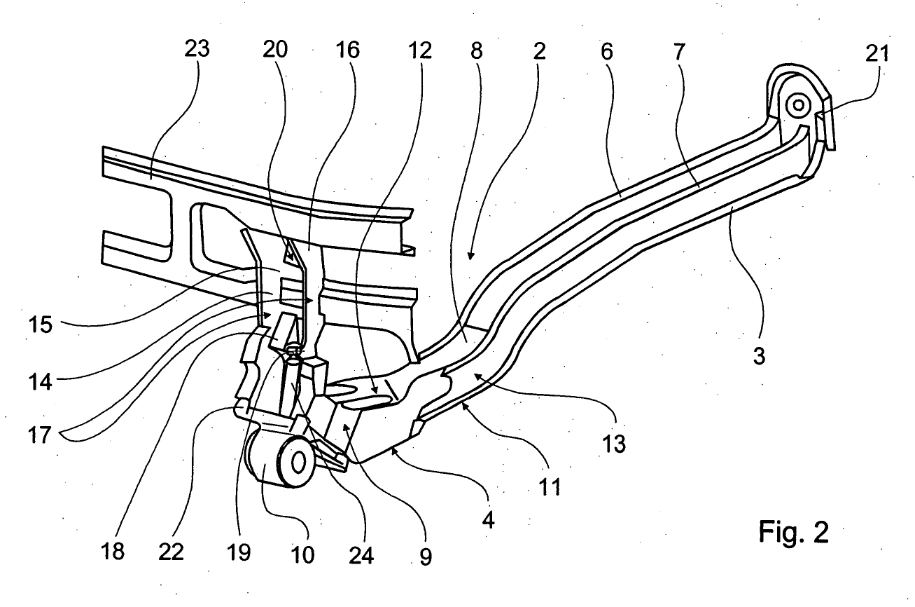

FIG. 2 shows a detailed illustration of one of the longitudinal beams 2. The longitudinal beam head 4 is formed in an angular manner from a first connecting piece 8 pointing to an essentially straight longitudinal beam section 3 and an upwardly protruding second connecting piece 14 and is manufactured from cast material. The first connecting piece 8 is of solid design and lies in a connecting region 11 in the longitudinal beam section 3 which is of U-shaped design having limbs 6, 7, which point upward in the direction of the floor plate 5. The first connecting piece 8 can be welded and/or screwed to the longitudinal beam section 3. A connection 13 for a tilting cylinder (not illustrated) for tilting the driver's cab is provided in the connection region 11.

The second connecting piece 14 is of approximately U-shaped design. A plurality of connections 13, 17, 18, 20, 22 is integrated in the longitudinal beam head 4. A connection 17 for a shock absorber for the mounting of the driver's cab is provided between webs 15, 16 of the second connecting piece 14, which webs protrude at an angle to an end wall 26. As an alternative, a connection 18 for a rotary bearing 19 of a damper can be provided between the webs 15, 16, which protrude at an angle, of the second connecting piece 14, for the mounting of the driver's cab.

Furthermore, a connection 20 for a pedal bracket and/or a steering column fastening, in particular for a combination bracket for the pedals and the steering column fastening, is provided on the second connecting piece 14.

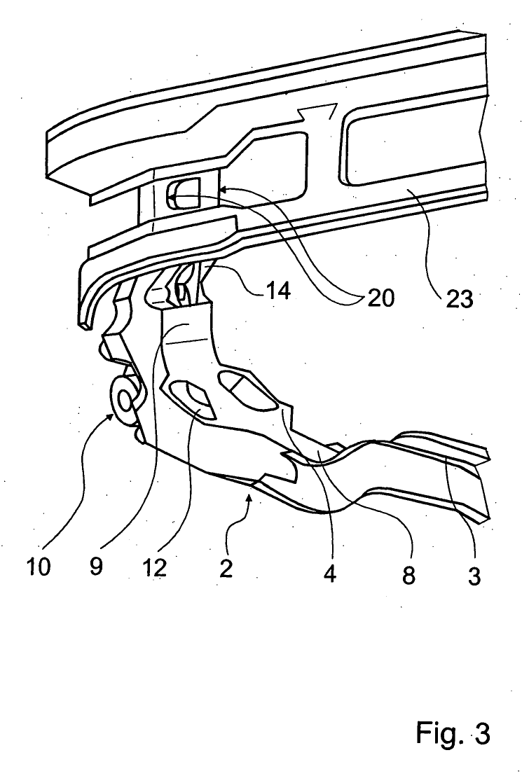

Furthermore, an aperture 12 for a steering column is provided in the first connecting piece 8 of the longitudinal beam head 4. This is illustrated on an enlarged scale and from a different viewing angle in FIG. 3. For the connection 20 of the pedal bracket or of the combination bracket, the transverse strut 23 has a corresponding aperture.

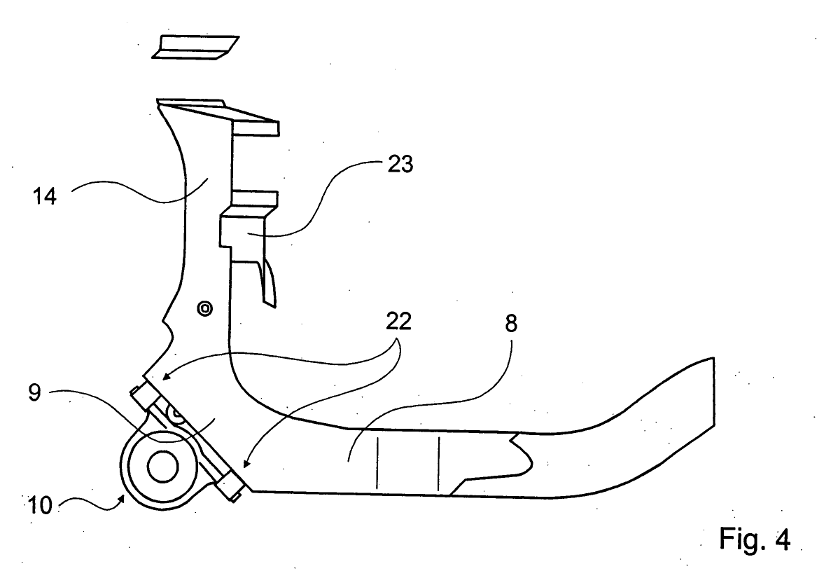

A connection 22 for a bracket 10 for the driver's cab is provided in the transition 9 of the longitudinal beam head 4 from the first to the second connecting piece 8, 14. This is illustrated in detail in FIG. 4. In order to change a pivotal point of the driver's cab, the bracket 10 can simply be exchanged for another one.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-15. (canceled)

16. A longitudinal beam for a driver's cab which extends upward in an angular manner beyond a floor plate, comprising: wherein
an essentially straight longitudinal beam section; and
a separate longitudinal beam head,
wherein the longitudinal beam head is assembled to the longitudinal beam section, the longitudinal beam head is formed in an angular manner from a first connecting piece pointing toward the longitudinal beam section and an upwardly protruding second connecting piece, and a plurality of connections are integrated in the longitudinal beam head.

17. The longitudinal beam as claimed in claim 16, wherein the first connecting piece is of solid design.

18. The longitudinal beam as claimed in claim 16, wherein the second connecting piece is of approximately U-shaped design.

19. The longitudinal beam as claimed in claim 18, wherein the longitudinal beam head is designed as a cast part.

20. The longitudinal beam as claimed in claim 19, wherein a connection for a shock absorber is provided between webs of the second connecting piece, said webs protrude at an angle to an end wall.

21. The longitudinal beam as claimed in claim 19, wherein a connection for a rotary bearing of a damper is provided between webs, which protrude at an angle, of the second connecting piece.

22. The longitudinal beam as claimed in claim 19, wherein a connection for at least one of a pedal bracket and a steering column fastening is provided on the second connecting piece.

23. The longitudinal beam as claimed in claim 17, wherein the longitudinal beam section is of U-shaped design, and an open side of the U shape is at an upward side of the longitudinal beam section.

24. The longitudinal beam as claimed in claim 23, wherein the longitudinal beam head projects with its first connecting piece into the U shape of the longitudinal beam section.

25. The longitudinal beam as claimed in claim 19, wherein a connection for a bracket for a driver's cab is provided in the transition of the longitudinal beam head from the first to the second connecting piece.

26. The longitudinal beam as claimed in claim 19, wherein an aperture for a steering column is provided in the first connecting piece.

27. The longitudinal beam as claimed in claim 19, wherein a connection for a tilting cylinder is provided in the region of the connecting region.

28. A carrier structure with at least two longitudinal beams as claimed in claim 16, wherein the at least two longitudinal beams are provided parallel to a vehicle longitudinal axis and their respective second connecting pieces protruding upward beyond a floor plate are connected to a transverse beam.

29. The carrier structure as claimed in claim 28, wherein the transverse beam is integrated in an end wall.

30. The carrier structure as claimed in claim 29, wherein a bracket is integrated in a transition between longitudinal beam and end wall.
